(19) United States
(12) Patent Application Publication
(10) Pub. No.: US 2016/0078060 A1
(43) Pub. Date: Mar. 17, 2016

(54) Providing Selective Access To A Database In A Size-Managed State

(71) Applicant: International Business Machines Corporation, Armonk, NY (US)

(72) Inventors: Joseph M. Gdaniec, Cary, NC (US); James P. Hennessy, Vestal, NY (US); Michael J. Howland, Endicott, NY (US)

(21) Appl. No.: 14/484,446

(22) Filed: Sep. 12, 2014

(51) Int. Cl. G06F 17/30

(52) U.S. Cl. CPC G06F 17/30289

(57) ABSTRACT

Embodiments relate to managing access to a database. A computer system for managing access to a database is provided. The computer system comprises a memory having computer readable instructions and a processor configured to execute the computer readable instructions. The instructions comprise determining that the database is in a size-managed state. The instructions further comprise denying access to the database based on determining that a received database command is for increasing a size of the database. The instructions further comprise allowing access to the database according to the received database command based on determining that the received database command is not for increasing the size of the database.

### BACKGROUND

The present invention relates generally to managing access to a database, and more specifically, to providing selective access to a database when the database is in a size-managed state.

In some cases, there is a limit on the size of a database over which the database may not grow. This limit is imposed to ensure that one particular database does not overwhelm other databases that occupy a storage space (e.g., a disk or a partition of a disk) allocated for the databases including the particular database. When the size of the database is close to the limit or exceeds the limit, the database enters into a transient state, in which a conventional database management system that manages the database provides little or no access to the database. For instance, the conventional database management system may provide a database client with a read-only access to the database and not allow the database client to modify the database. As a result, the database remains in a transient state, and the client will not be able to modify data stored in the database unless an administrator of the database intervenes by, e.g., reducing the size of the database or increasing the limit on the size of the database.

### SUMMARY

Embodiments include a computer program product, a method, and a system for managing access to a database. According to an embodiment of the present invention, a computer program product for managing access to a database is provided. The computer program product comprises a computer readable storage medium having program instructions embodied therewith. The program instructions readable by a processing circuit cause the processing circuit to perform a method. The method determines that the database is in a size-managed state. Based on determining that a received database command is for increasing a size of the database, the method denies access to the database. Based on determining that the received database command is not for increasing the size of the database, the method allows access to the database according to the received database command.

According to another embodiment of the present invention, a method of managing access to a database is provided. The method determines that the database is in a size-managed state. Based on determining that a received database command is for increasing a size of the database, the method denies access to the database. Based on determining that the received database command is not for increasing the size of the database, the method allows access to the database according to the received database command.

According to a further embodiment of the present invention, a computer system for managing access to a database is provided. The computer system comprises a memory having computer readable instructions and a processor configured to execute the computer readable instructions. The instructions comprise determining that the database is in a size-managed state. The instructions further comprise denying access to the database based on determining that a received database command is for increasing a size of the database. The instructions further comprise allowing access to the database according to the received database command based on determining that the received database command is not for increasing the size of the database.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram of a database management system according to an embodiment of the invention; and

FIG. 2 depicts a process flow for managing access to a database according to an embodiment of the invention.

### DETAILED DESCRIPTION

When a database is in a transient state, a conventional database management system that manages the database provides little or no access to the database. For instance, a conventional database management system may provide a database client with a read-only access to the database and not allow the database client to modify the database when the database is in a transient state. In some cases, the conventional database management system puts a particular database into a transient state when the size of the particular database is close to or exceeds a size of a storage space (i.e., a storage quota) allocated for the particular database.

The database remains in a transient state until an administrator of the conventional database management system intervenes by, e.g., reducing the size of the database or increasing the limit on the size of the database. Keeping the database in a transient state may result in having incorrect information in the database because, for example, the database may not be updated with new information, with which the database client attempts to update the database while the database is in a transient state. Also, the conventional database management system may lose an opportunity to take the database out of a transient state without an administrator intervention because the database client's access to the database to reduce the size of the database would be denied while the database is in a transient state.

The systems and methods of some embodiments of the invention provide selective access to a database while the database is in a size-managed state so as to prevent the database from entering a transient state, in which useful access to the database is not provided as described above for a conventional database management system. The systems and methods put a database in a size-managed state when the database is near or over the database's storage quota. The systems and methods allow a database client to access a database in a size-managed state as long as the client's access would not result in an increase of the size of the database. Specifically, the systems and methods allow the database client to modify or read the database (e.g., update data in the database or remove data from the database) in a size-managed state as long as the size of the database would not increase. That is, the systems and methods allow the database client to reduce the size of the database or read the database in a size-managed state. The systems and methods also allow the database to read data from the database (e.g., query the database) in a size-managed state.

As known in the art, a database is an organized collection of data. It is to be noted that, although a database may be implemented in a file system, a database is different than a file in a file system. For example, a database is accessed by using a set of commands that are specific to databases (e.g., Structured Query Language (SQL) statements such as INSERT, DELETE, UPDATE, MERGE, etc.) while a file is accessed by using a set of commands specific to a file system (e.g., UNIX commands such as ls, my, cp, etc.). Persons of the ordinary skill in the art will recognize other differences between databases and files in a file system.

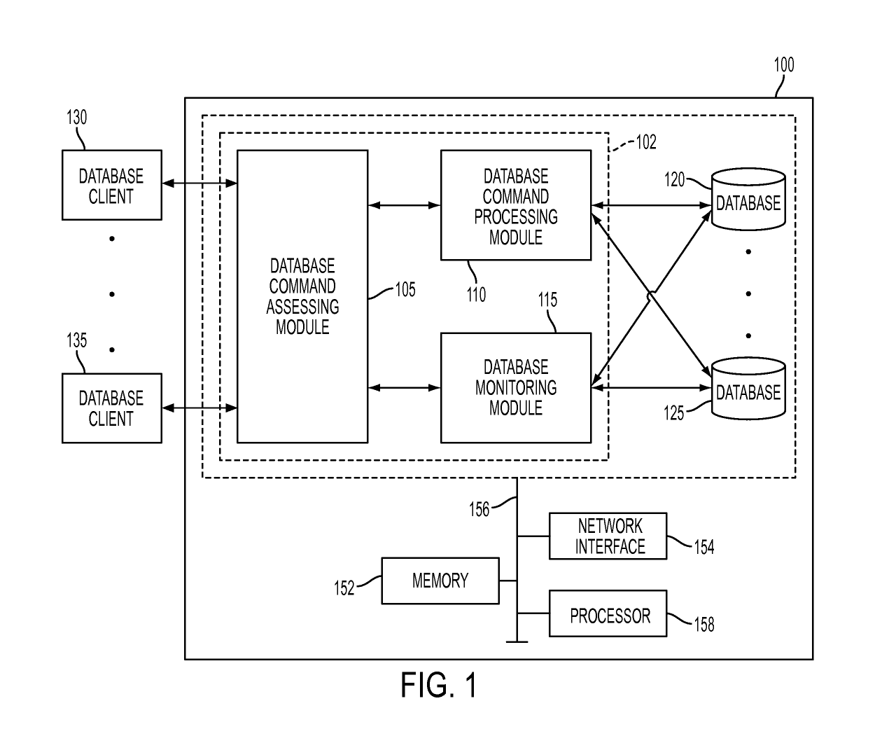

FIG. 1 illustrates a system 100 for managing access to a database in accordance with some embodiments of the invention. The system 100 of some embodiments includes a database command assessing module 105, a database command processing module 110, a database monitoring module 115 and databases 120 and 125. FIG. 1 also illustrates database clients 130 and 135.

The database clients 130 and 135 are configured to access the databases 120 and 125 to read, write, insert, delete, or otherwise modify data in the databases 120 and 125. In some embodiments, the database clients may be software components, scripts, or user interfaces that access the databases 120 and 125 by sending one or more database commands to the system 100 that hosts the database 120 and 125. The database clients 130 and 135 may operate in devices (not shown) that are remote to the system 100. The database clients 130 and 135 may operate within the system 100. In some embodiments, each of the database clients 130 and 135 is configured to access only one of the databases 120 and 125.

The database command processing module 110 is configured to process database commands that originate from the database clients 130 and 135. Specifically, in some embodiments, the database command process module 110 performs a set of operations on the database 120 or 125 according to a database command. For instance, when the database command includes a SQL DELETE statement, the database command processing module 110 performs a set of operations to delete data (e.g., a row from a table) specified by the SQL DELETE statement from the database. As another example, when the database command includes a SQL INSERT statement, the database command processing module 110 performs a set of operations to insert data (e.g., a row into a table) specified by the SQL statement. Persons of the ordinary skill in the art will recognize that there may be numerous other SQL statements (e.g., CREATE, MERGE, TRUNCATE, DROP, etc. to name a few) that a database command may include.

The database monitoring module 115 is configured to monitor the sizes of the databases 120 and 125 that vary as a result of processing database commands by the database command processing module 110. Specifically, in some embodiments, the database monitoring module 115 checks the sizes of the databases against the storage quotas assigned to the databases 120 and 125. In these embodiments, the database monitoring module 115 puts the database 120 or 125 in a size-managed state if the size of the database 120 or 125 is close to the storage quota (e.g., over a predetermined percentage of the storage quota such as a 90%) or exceeds the storage quota (e.g., 10 megabytes (MB)). Alternatively or conjunctively, the database monitoring module 115 checks the collective size of the databases 120 and 125 against a collective storage quota (e.g., 100 MB for ten databases) and puts the databases 120 and 125 into a size-managed state if the collective size of the databases 120 and 125 is close to (e.g., over a predetermined percentage of the collective storage quota such as a 90%) or exceeds the storage quota. In some embodiments, the database monitoring module 115 maintains state information for the databases 120 and 125. That is, the database monitoring module 115 keeps track of the states of the databases 120 and 125 in which the database 120 and 125 are. In some embodiments, the states, in which the database 120 and 125 may be, include a size-managed state and a normal state. In a normal state, the database clients 130 and 135 have full access to the databases 120 and 125.

The database command assessing module 105 is configured to assess the database commands received from the database clients 130 and 135 when the database monitoring module 115 determines that a particular database, which the database commands are used to access, is in a size-managed state. Specifically, in some embodiments, when the particular database is in a size-managed state, the database command assessing module 105 determines whether a received database command, when processed by the database command processing module 110, would increase, decrease or not affect the size of the particular database. For instance, when a received database command is a SQL DELETE statement for deleting data from the database 120, the database command assessing module 105 determines that the received command is for reducing the size of the database 120. As another example, when a received database command is a SQL INSERT statement for adding data to the database 120, the database command assessing module 105 determines that the received command is for increasing the size of the database 120. As yet another example, when a received database command is a SQL SELECT statement for querying the database 120, the database command assessing module 105 determines that the received command is for not affecting or changing the size of the database 120.

When the database command assessing module 105 determines that a received database command would increase the size of the particular database and that the particular database in a size-managed state, the database command assessing module 105 denies access to the database by, for example, not passing the received command to the database command processing module 110. That is, a set of operations for the database command will not be performed on the database by the database command processing module 110. When the database command assessing module 105 determines that a received database command would not increase the size of the particular database in a size-managed state (i.e., when the database command assessing module 105 determines that the received database command would decrease or maintain the size of the particular database in a size-managed state), the database command assessing module relays the received database command to the database command processing module 110 so that the database command processing module 110 performs a set of operations on the database for the database command. In some embodiments, the database command assessing module 105 relays all of the received database commands to the database command processing module 110 without assessing the received database commands when the database monitoring module 115 determines that the particular database is not in the size-managed state.

In some embodiments, the databases 120 and 125 are communicatively coupled to the database command processing module 110 and the database monitoring module 115. In some embodiments, the databases 120 and 125 may be implemented within the system 100. In other embodiments, the databases 120 and/or 125 may be implemented in storage systems that operate separately from the system 100.

In some embodiments, the databases 120 and 125 are managed by a database management system (DBMS) 102 that includes the database command assessing module 105, the database command processing module 110 and the database monitoring module 115. In some embodiments, this DBMS 102 manages the databases 120 and 125 autonomously. That is, this DBMS 102 operates without being administered by an administrator or operates with little and infrequent administration by the administrator. Specifically, the administrator does not intervene or does not often intervene to change the database state from a size-managed state to a normal state by, for example, reducing the size of a database or increasing the storage quota of the database.

In some embodiments, the system 100 that includes the databases 120 and 125 and the DBMS 102 is an embedded system operating within a firmware of a computer system (not shown). In some such embodiments, the database clients 130 and 135 are software components running in the computer system. The database clients 130 and 135 of these embodiments access the databases 120 and 125 to store information resulting from the operations of the software components (e.g., logging information) in the form of databases. In these embodiments, the DBMS 102 is configured to manage the databases 120 and 125 autonomously.

As used herein, the terms module and sub-module may refer to an application specific integrated circuit, an electronic circuit, a processor (shared, dedicated, or group) and memory that executes one or more software or firmware programs, or a combinational logic circuit in a server. For example, in some embodiments, the database command assessing module 105 may be communicatively connected (e.g., through a bus 156) to a memory 152 to store and retrieve the database commands from the database clients 130 and 135, and to a network interface 154 to communicate with the database clients 130 and 135. The database command assessing module 105 may also use a processor 158 to perform the database command assessment operations described above. The database command processing module 110 and the database monitoring module 115 may also use the processor 158 to perform their respective operations described above. Furthermore, the databases 120 and 125 may be implemented in the memory 152 so that the database command processing module 110 and the database monitoring module 115 communicate with the databases 120 and 125. In some embodiments, the modules of the system 100, namely a database command assessing module 105, a database command processing module 110 and a database monitoring module 115 may be combined or further partitioned. For instance, the modules 105-115 may be combined into the DBMS 102. The modules of the system 100 may be implemented in more than one physical machine in a distributed fashion.

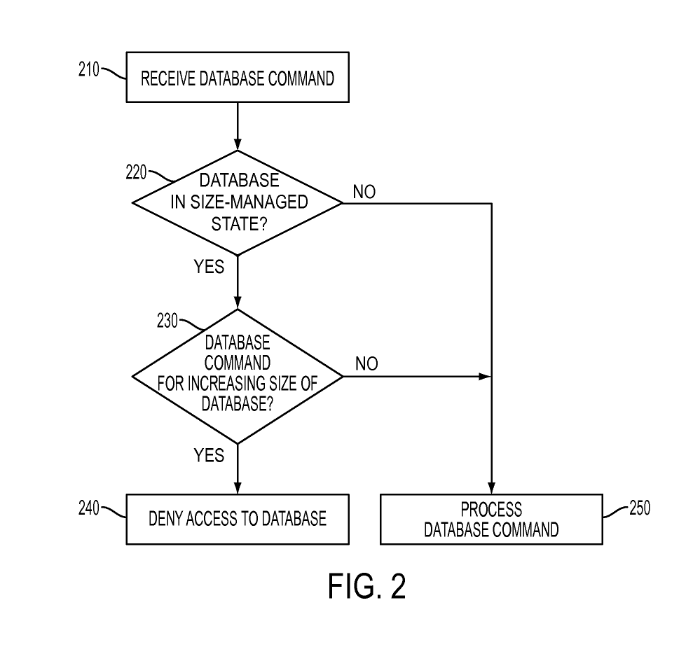

FIG. 2 depicts a process flow for managing access to a database in accordance with some embodiments of the invention. In some embodiments, the system 100 performs the process flow shown in FIG. 2. At block 210, the system 100 receives a database command from one of the database clients 130 and 135. In some embodiments, the received database command indicates which of the databases 120 and 125 the database client intends to access. In some embodiments, the databases 120 and 125 are autonomously managed. In some embodiments, the system 100 is embedded in the chassis of a mainframe computer.

At block 220, the system 100 determines whether the database that the database client intends to access is in a size-managed state. In some embodiments, the system 100 puts a database into a size-managed state when the size of the database exceeds a storage quota allocated for the database. The database may be one of a plurality of databases having a collective storage quota allocated for the plurality of databases. The system 100 puts the databases into a size-managed state when a collective size of the plurality of databases exceeds the collective storage quota. When the system 100 determines that the database is in a size-managed state, the system 100 proceeds to block 230, which will be described further below. When the system 100 determines that the database is not in a size-managed state, the system 100 proceeds to block 250 to process the database command received at block 210. In some embodiments, the system 100 processes the database command by performing a set of operations for the database command.

At block 230, the system 100 determines whether the database command received at block 210 is for increasing the size of the database. In some embodiments, the received database command includes a SQL statement. The system 100 determines that a SQL DELETE statement is for reducing the size of the database, that a SQL INSERT statement is for increasing the size of the database, and that SQL SELECT statement is for maintaining the size of the database.

Based on determining at block 230 that the received database command is not for increasing the size of the database (i.e., based on determining at block 230 that the received database command is for reducing the size of the database or for not changing the size of the database), the system 100 at block 250 processes the received database command by reducing or maintaining the size of database according to the received database command.

Based on determining at block 230 that the received database command is for increasing the size of the database, the system 100 at block 240 denies access to the database. That is, the system at block 240 maintains the size of the database without performing any database operation on the database—i.e., the system at block 240 does not process the database command received at block 210. At block 240, the system 100 also optionally notifies the database client, from which the database command originates, that access to the database is denied and the database command is not processed because the database is currently in a size-managed state.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1.-14. (canceled)

15. A computer system for managing access to a database, comprising:
a memory having computer readable instructions; and
a processor configured to execute the computer readable instructions, the instructions comprising:
determining that the database is in a size-managed state;
based on determining that a received database command is for increasing a size of the database, denying access to the database; and
based on determining that the received database command is not for increasing the size of the database, allowing access to the database according to the received database command.

16. The computer system of claim 15, wherein the instructions further comprise:
based on determining that a received database command is for reducing a size of the database, reducing the size of database according to the received database command; and
based on determining that the received database command is for reading the database, maintaining the size of data stored in the database.

17. The computer system of claim 15, wherein the instructions further comprise:
based on determining that the size of the database exceeds a storage quota allocated for the database, putting the database into the size-managed state.

18. The computer system of claim 15, wherein the database is one of a plurality of databases having a collective storage quota allocated for the plurality of databases, wherein the instructions further comprise:
based on determining that a collective size of the plurality of databases exceeds a predetermined percentage of the collective storage quota, putting the database into the size-managed state.

19. The computer system of claim 15, wherein the computer system is embedded in a mainframe computer.

20. The computer system of claim 15, wherein the received database command comprises a Structured Query Language (SQL) statement, wherein the instructions further comprise:
determining that a SQL DELETE statement is for reducing the size of the database;
determining that a SQL INSERT statement is for increasing the size of the database; and
determining that a SQL SELECT statement is for maintaining the size of the database.
